(19) United States
(12) Patent Application Publication
(10) Pub. No.: US 2013/0096989 A1
(43) Pub. Date: Apr. 18, 2013

(54) Method and System for Determining Freight Shipping Pricing Based on Equipment Type, Market Geographies, Temporal Currency, and Trip Type Characteristics

(71) Applicant: TransCore Commerical Services, LLC, Beaverton, OR (US)

(72) Inventors: Timothy Michael Dale, Canby, OR (US); Ralph Anthony Galantine, Lake Oswego, OR (US); Mark Timothy Montague, Beaverton, OR (US)

(73) Assignee: TRANSCORE COMMERICAL SERVICES, LLC, Beaverton, OR (US)

(21) Appl. No.: 13/651,879

(22) Filed: Oct. 15, 2012

Related U.S. Application Data
(60) Provisional application No. 61/548,330, filed on Oct. 18, 2011.

(51) Int. Cl. G06Q 30/02

(52) U.S. Cl. 705/7.34

(57) ABSTRACT

A system and method of determining the shipping price rates of goods being shipped using a unique integration of geographic areas, rate data and shipping trip types. The geographic areas are defined in terms of similar market characteristics, the rate data is defined in terms of age and shipping trip types are defined in terms of distance as well as in terms of distance involving overlaps for adjacent shipping trip types. Expansion rules are provided for each of these categories that permit these categories to be expanded or contracted to achieve minimum data requirements when calculating the shipping price rates. Pertinent data is collected from a variety of source systems using FTP, email and other web services which is then passed to a data acquisition/integration system for data extraction and reconfiguration. A rate engine then uses that data and implements the method to calculate the shipping price rates by using the respective expansion rates of the different categories based on a user's particular shipping price request.

### CROSS-REFERENCE TO RELATED APPLICATIONS

This utility application claims the benefit under 35 U.S.C. §119(e) of Provisional Application Serial No. 61/548,330 filed on Oct. 18, 2011 entitled METHOD FOR DETERMINING FREIGHT SHIPPING PRICE BASED ON EQUIPMENT TYPE, MARKET GEOGRAPHIES, TEMPORAL CURRENCY AND TRIP TYPE CHARACTERISTICS and whose entire disclosure is incorporated by reference herein.

### BACKGROUND OF THE INVENTION

1. Field of Invention

This invention relates to the field of shipping goods and, in particular, to the field of determining the shipping price rates of goods being shipped.

2. Description of Related Art

Prior to 1980 and the deregulation of the trucking industry, a system of shipping rates, i.e., the price to ship goods, existed which was based on city names. When a city was considered of minor importance or less identifiable with a lane than another nearby city, it was assigned to a basing point. For example, Chicago Ill. served as the basing point for a number of nearby smaller cities. Also, sizeable cities at a distance of 25-40 miles from Chicago served as basing points, for example Elgin, Aurora and Joliet, Ill.

Rates were determined by taking the pair of cities for which one wished to establish a rate, determining their respective basing points and then going to a table of rates for the appropriate rate based upon the commodity and weight of the shipment. This was true for truckload as well as less-than-truckload (LTL) rates.

The irregular route truckload carriers in existence in 1980 also had a system of published rates which was usually for a specific commodity between two specific points. Because their grant of authority under the International Commerce Commission (ICC) was highly defined most truckload carriers did not need a table of general application. When they did possess the broader authority, the rates were often published in distance format, since a backhaul (i.e., a return of the truck back to its point of origin) was not necessarily required by the rate levels in place.

The Motor Carrier Act of 1980 eliminated fixed route and commodity restraints. Furthermore, it permitted entry to the trucking industry for anyone willing and able under ICC standards to haul a shipment for hire, in all except the high value merchandise and household goods areas.

The procedures established to regulate the railroads in 1890 served as a model for truckling regulation that ensued in 1935. Because of the slowness of the ICC to react to requests for rate changes, transportation pricing was not very dynamic. Each stakeholder could protest any change in rates. Entry into trucking was barred by the need of the applicant to have multiple supporters, to show that existing providers failed to deliver the required service, and to answer any challenges by competitors.

Hence development of pricing was not very computerized, even in 1980. It consisted mostly of manual lookups which could take 10-15 minutes per movement. Many firms made a business out of auditing rates and uncovering errors, and working on a percentage of the discovered variance from the legal published rate.

After deregulation, a better system of creating rates and managing rates was required. Early industry entrants soon adopted United States Postal Service Zone Improvement Plan (“ZIP”) code based rating schemes, because ZIP codes were numeric, had a geographical basis, and were used in shipping addresses. ZIP codes therefore served as a standard reference point that both shipper and carrier could understand. Truckload ZIP code rates began appearing about 1984, and by the end of the decade all major U.S. truckload carriers were using ZIP code based schemes

Other pricing schemes in use included a table of specific commodity rates from one origin city to many named cities, and tables of generalized state-to-state matrices which were often given more specificity by subdividing large and heavily populated states into zones. At first, these zones were described by language which paralleled the ICC-granted authority, for example US highway 281 was a major designator between east Texas and west Texas.

However these designators, which could also include rivers, counties and mountain ranges, were difficult or impossible to describe for the increased level of computerization the industry was adopting. Even commercial zones, described as a region consisting of a specific point and a radius determined by city size, fell out of favor. They were eventually replaced by a ZIP code description.

About 1990 truckload pricing began to be less determined by historical precedents and more by ease of information handling. By 1995, intrastate trucking regulation was largely eliminated by a decision of the ICC, which shortly thereafter was itself disbanded by the U.S. Congress. Remaining functions were parceled out to the Departments of Commerce, Transportation and Energy. This further opened the door to streamlined rating, since much of truck transport was short haul. An added benefit to shippers was that standardized practices between competitors led to ease of comparing rate data. This led to the modern transportation Request for Proposal (RFP). As shippers continued to pursue more advanced strategies, such as establishing core carriers, these further motivated carriers to adopt flexible ZIP code based pricing strategies.

ZIP codes were originally established by the United States Postal Service (USPS) to facilitate the computerized handling of mail. Therefore, there is a natural geographical component to ZIP codes. The first three digits of the ZIP code have special significance because the USPS established its bulk mail centers based on them. Hence, densely populated markets have a unique three-digit ZIP code identifier (the Sectional Center Facility code) or series of three-digit identifiers which define the area. Also, the three-digit level is sequential within a state so that a range of three-digit ZIP codes can be set to describe a state or even a region. As information, the last two digits were assigned randomly, except that in most cases the base municipal post office was assigned ‘01’ and Fleet Post Office (FPO), if any, was assigned ‘00’. Hence, in Saint Louis Mo. the main post office is found at 63101, and all other places within St. Louis start with 631. Places surrounding St. Louis start with 630, except for St. Charles, a large suburb starting with its own ZIP 633.

Some further examples can include Cleveland Ohio which has a three-digit ZIP code 441, with suburbs that start with the three-digit code 440. St. Paul has a three-digit ZIP code 551, and its suburbs start with 550, 553. Minneapolis Minn. has a three-digit ZIP code 554, and its suburbs start with ZIP codes 550, 553. Milwaukee Wis. has a three-digit ZIP code 532, with suburbs that start with ZIP codes 530, 531. ZIP code 588 covers a large section of northwest North Dakota including Williston N. Dak. ZIP code 798 covers a large section of southwest Texas closest to El Paso Tex., which has a ZIP code 799.

However, the use of ZIP codes, by themselves, to determine shipping pricing does not produce satisfactory results. For example, the use of the 905 ZIP codes in active use creates a potential matrix of 905×905 results or 819,025 pair points. Each pair point would further require multiple rate records to produce statistically satisfactory shipping rates. Therefore, it would be extremely difficult to generate the data density required to produce rates at the ZIP code level.

On the other end of the scale, the industry commonly reports data at the state level. This is useful for a homogenous region, as may be represented by Connecticut or New Jersey, since both are relatively small states. However, it does not work very well for large states like California, Florida, Pennsylvania or Texas, each of which contain several different climates, industries, and operating conditions.

It is known in the art to use ZIP codes for many operations other than determining shipping rates in the shipping industries. For example, U.S. Pat. No. 7,263,495 issued to Rodriguez on Aug. 28, 2007 discloses the use of ZIP codes in an order scheduling system for distributing product orders to multiple fulfillers. The Rodriquez system attempted to minimize the number of orders across fulfillers, to thereby minimize the total shipping costs. In order to do this, orders were placed with fulfillers that were geographically nearest the delivery addresses of the recipients of the orders. Therefore, the geographical proximity of each fulfiller to the delivery address was calculated. The three most significant ZIP code prefixes, and the corresponding postal zones, of the fulfillers and the delivery were used to perform the calculations. The calculations were repeated for all fulfillers, starting from fulfillers having adjacent ZIP codes. All fulfillers were ranked from the closest to the farthest, for each order to be fulfilled.

U.S. Pat. No. 4,024,380 issued to Gunn on May 17, 1977 discloses a self service postal apparatus for sorting packages and other postal articles. The user of the Gunn apparatus first entered the ZIP code in which the apparatus was to be operated. Subsequently, the user entered the ZIP codes of any addressees of packages or articles to be mailed. The apparatus then displayed the geographic locations of the entered destination ZIP codes, to permit the user to verify the accuracy of the addressee ZIP code as entered. The postage was then calculated for the user, based on the ZIP code. Thus, while the Gunn apparatus could calculate the postage between two ZIP codes, it could not calculate the more complicated shipping rates between the various locations.

Other systems of general interest in the field of applying ZIP codes to commercial activity include U.S. Pat. No. 6,583,825 issued to Yuen on Jun. 24, 2003, which discloses a system for transmitting and downloading setup information. The setup information included channel maps, which were used for mapping the televised channels available to the users of the system to the channels actually present on the tuners of the users. ZIP codes or ZIP code ranges were used as channel map identifiers in the Yuen system. The appropriate channel maps varied widely from one user location to another. However, the maps were uniform within ZIP codes or within ZIP code ranges. Additionally, U.S. Pat. No. 7,168,084 issued to Hendricks on Jan. 23, 2007 discloses the use of ZIP codes, along with information such as demographic information, for targeting virtual objects of video games.

All references cited herein are incorporated herein by reference in their entireties.

### BRIEF SUMMARY OF THE INVENTION

In the system and method of the invention, when the user initiates a shipping rate calculation, the system returns a rate based on the input equipment type (e.g., flatbed trailer, van trailer, refrigerated van trailer, etc.) required to haul the shipment, the shipment's origin point, the shipment's destination point, and any other pertinent shipment and handling considerations. The returned rate is calculated by analyzing actual shipment rate data, collected from the industry, according to the dimensions of equipment type, geographic locality, temporal currency (age of the rate data), and trip type characteristics.

In particular, a method for determining the shipping price rates of goods to be shipped in geographic areas is disclosed. The method comprises: defining geographic areas in terms of similar market characteristics (e.g., a postal area, a key market area, an expanded market area, a market region, a state, a zone, a nation, etc.); defining age of rate data (e.g., based upon the pick-up date with respect to the current date); defining a respective set of expansion rules for the geographic areas and the age of rate data; associating the expansion rules of the geographic areas and the age of rate data; alternately expanding and contracting the geographic areas with the age of rate data based on a request for a shipping rate for goods between a particular origin and a particular destination to determine the shipping price rate therebetween, and wherein the alternate expanding and contracting meets respective minimum requirements of the geographic areas and the age of rate data.

A system for determining the shipping price rates of goods to be shipped in geographic areas is disclosed. The system comprises: at least one computer system that provides source system data pertaining to shipping rates; a rate engine that receives the source system data from the at least one computer system, wherein the rate engine calculates the shipping price rates of goods to be shipped from an association of expansion rules of predefined geographic areas that are defined in terms of similar market characteristics (e.g., a postal area, a key market area, an expanded market area, a market region, a state, a zone, a nation, etc.); and expansion rules of predefined age of rate data (e.g., based upon the pick-up date with respect to the current date), and wherein the rate engine alternately expands and contracts the predefined geographic areas with the predefined age of rate data based on a user request for a shipping rate for goods between a particular origin and a particular destination to determine the shipping price rate therebetween, and wherein the alternate expanding and contracting meets respective minimum requirements of the geographic areas and the age of rate data; and at least one computer of a user, making the request, for receiving the determined shipping price rate.

The calculated rate must meet predetermined minimum standards, such as a minimum number of different rate data contributors and a minimum number of rate records, plus other statistical considerations. These minima and considerations are controlled by the operators of the invention. An embodiment of the invention requires a minimum of seven rate records from three unique contributors. Another embodiment varies the minimum number of required rate records depending on geography, with twelve for smaller geographies and eight for larger geographies.

In order to insure these standards are satisfied, the system and method of the invention can expand its analysis of rate records to include successively wider geographic locality, and/or less temporal currency (i.e., older rate records), and/or less stringent application of trip type characteristics. The system and method of the invention includes business rules for the expansion of these dimensions.

### BRIEF DESCRIPTION OF SEVERAL VIEWS OF THE DRAWINGS

The invention will be described in conjunction with the following drawings in which like reference numerals designate like elements and wherein:

FIGS. 1A-1B show a process flow representation of the system and method of the present invention.

FIG. 2 shows a more detailed block diagram representation of portions of the system and method of FIG. 1.

FIGS. 3A-3B show a more detailed block diagram representation of portions of the system and method of FIG. 1.

### DETAILED DESCRIPTION OF PREFERRED EMBODIMENTS OF THE INVENTION

Equipment Type. Rates can be calculated based on the general equipment type used to ship the freight. The industry has traditionally and historically established rates differentiated by equipment type because of significant variations in the operating cost and supply and demand among different equipment types. The preferred implementation considers the equipment types “van”, “reefer” (i.e., refrigerated vans), and “flatbed”. Additional equipment types, such as intermodal and tankers, can be naturally accommodated by the system and invention.

Geography. An important feature of the invention is the definition of the geographic areas. Rather than using strictly political or natural geographic boundaries, the invention defines geography in terms of similar market characteristics. These market characteristics include, but are not limited to, (1) proximity to a major city or transportation hub (similar to the above-described “basing point”); (2) proximity or influence of major truck, rail, marine, or air transportation routes; (3) population demographics, particularly those that influence production and consumption of goods; (4) influence of particular inbound and/or outbound commodities; (5) natural barriers that strongly influence the behavior of transportation; (6) political boundaries and regulatory influences on the behavior of transportation; and (7) traditional and historical market areas well understood in the industry.

Key Market Area. The foundational geography in the system and invention is the key market area. A key market area is a geography defined to encompass similar market characteristics, as described above, using the inventor's knowledge of the industry. The preferred implementation currently has approximately 150 key market areas defined, covering the entire contiguous United States and Canada. Alaska, Hawaii, Puerto Rico, and other offshore territories and possessions of the United States and Canada are not currently included in the preferred implementation but are naturally accommodated by the system and invention should the need arise.

The physical geographic area of a key market area can be defined in terms of its constituent postal areas. For those key market areas which reside in the United States, a postal area is defined as that area served by a United States Postal Service Sectional Center Facility (SCF). For convenience, these areas are commonly referenced by the first three digits of a USPS ZIP code. As an example from the preferred implementation, the Portland, Oreg. key market area is defined to be the geographic area encompassed by the USPS Sectional Center Facilities for ZIP codes whose first three digits are 970, 971, 972, 973, and 986. For those key market areas which reside in Canada, a postal area is defined as the area served by a Canada Post (CP) Forward Sortation Area (FSA), denoted by the first three characters of a CP postal code. Alternate geographic definitions could have been used, such as US Office of Management and Budget “core based statistical areas” (CBSA) or “metropolitan statistical areas” (MSA), US Census Bureau “census tracts”, or any other reasonable geographic system. However, the preferred implementation uses SCF/FSA postal areas because of a long tradition of use and deep understanding by participants in the industry. Key market areas can also be defined for Mexico, using Mexico postal codes, which are likewise geographically based.

Expanded Market Area. If a key market area does not contain enough relevant rate data from which to compute a rate that meets the aforementioned minimum criteria, the market geography under consideration can be expanded outward from the key market area. This larger Expanded Market Area can contain additional postal areas which are contiguous with those comprising the key market area and of similar market characteristics to the key market area. As an example from the preferred implementation, the Portland, Oreg. key market area is expanded from SCFs 970, 971, 972, 973, and 986 to define an expanded market area that also includes SCFs 974 and 985. These two SCFs reside in other key market places, but have enough similar market characteristics to make them reasonable for inclusion in the expanded market area for Portland, Oreg. Expanded market areas may have some geographic overlap with other expanded market areas, which likewise means a postal area may reside in multiple expanded market areas. However, a postal area can reside in just one key market area. In the preferred implementation there is an expanded market area defined for each defined key market area.

Market Region. If an expanded market area does not contain enough relevant rate data from which to compute a rate that meets the aforementioned minimum criteria, the market geography under consideration can again be expanded outward from the expanded market area. This larger Market Region contains additional postal areas which are contiguous with those comprising the expanded market area, and of similar market characteristics on a regional basis. A market region contains multiple key market areas and expanded market areas. Any particular key market area resides in just one market region. Likewise, any particular expanded market area resides in just one market region. Market regions do not geographically overlap with other market regions. The preferred implementation currently has 18 market regions defined for the United States and Canada.

State/Province. If a key market area or an expanded market area does not contain enough relevant rate data from which to compute a rate that meets the aforementioned minimum criteria, the market geography under consideration can be expanded to the state/province level. While states and provinces are politically-defined geographies, and not based on market characteristics, they are a well-established traditional means by which to view, analyze, and quote shipping rates. For Canada, the preferred implementation makes no distinction between provinces and territories, treating the latter as provinces.

Zone. If a state/province still does not contain enough relevant rate data from which to compute a rate that meets the aforementioned minimum criteria, the state/province can be expanded up a Zone. A zone is a collection of states/provinces. In the preferred implementation, the United States is covered by ten zones, each composed of all the states which share the same first digit of their collective ZIP codes (in the USPS system, all the ZIP codes in a state start with the same digit). For example, zone “Z7” is comprised of Texas, Oklahoma, Louisiana, and Arkansas. The United States is thus wholly mapped by ten zones. In the preferred implementation, Canadian zones are collections of provinces. For example, zone “ZE” represents eastern Canada, composed of New Brunswick, Newfoundland, Nova Scotia, and Prince Edward Island; zone “ZC” is central Canada, composed of Quebec and Ontario. Zone “ZW” is composed of Alberta, British Columbia, Manitoba, and Saskatchewan. In another embodiment of the invention, other zones can be defined. For example, it is possible to define a new “ZD” zone which is all of Canada, or a “ZB” zone composed of the provinces that are contiguous to the United States. Similar zones can be defined for Mexico. Zones are not as strongly market-related as market regions (see above), but have a long tradition of use and understanding in the industry.

Nation. If a zone or a market region still does not contain enough relevant rate data from which to compute a rate that meets the aforementioned minimum criteria, the state/province can be expanded up a Nation. This is the widest geographic level of expansion.

Geographic Expansion. As mentioned in the above geographic definitions, the system and invention considers rate information in successively expanding geographic areas until it satisfies the minimum requirements for calculating a rate. A set of expansion rules is used to guide this process. One possible set of rules that has been implemented is illustrated below in Expansion Rules Table I:

EXPANSION RULES TABLE I

| Order of | | |
|---|---|---|
| Expansion | Origin | Destination |
| 1 | Postal Area | Postal Area |
| 2 | Postal Area | Key Market Area |
| 3 | Key Market Area | Key Market Area |
| 4 | Key Market Area | Expanded Market Area |
| 5 | Expanded Market Area | Expanded Market Area |
| 6 | Expanded Market Area | Market Region |
| 7 | Market Region | Market Region |

The above rules demonstrate the consideration of rate data from increasingly larger market geographies.

Expansion Rules Table II illustrates another set of expansion rules that have been implemented, and demonstrate a mix of considering rate data from both increasingly larger market geographies and non-market geographies:

EXPANSION RULES TABLE II

| Order of | | |
|---|---|---|
| Expansion | Origin | Destination |
| 1 | Postal Area | Postal Area |
| 2 | Postal Area | Key Market Area |
| 3 | Key Market Area | Key Market Area |
| 4 | Key Market Area | State |
| 5 | State | State |
| 6 | Zone | Zone |

Temporal Currency. In addition to considering rate data based on geography and expansion to larger geographies in order to calculate rates which satisfy certain minimum requirements, the dimension of temporal currency, i.e., the age of the rate data, is also considered. “Age” refers to the pick-up date of the freight. Therefore, if today is September 1, and the rate data specifies a freight pick-up date of August 28, then the age of the data is four days. If the rate data specifies a freight pick-up date of today, then the age of the data is zero days.

Temporal Expansion. Whereas in order to calculate a rate that satisfies certain minimum requirements, rate data from increasingly larger geographies is considered, likewise, increasingly older rate data can be considered. In general, new data is preferred in the industry because it most accuracy reflects current shipping activity and factors that are affecting the current cost of shipping, such as changes in the supply and demand of trucks, load volume, fuel price volatility, natural disasters, seasonality of commodities, or closures and detours of transportation routes. In the preferred embodiment of the invention, the age of the data used to calculate the rate for a given geography can be expanded or contracted. For example, the calculation may use the costs of shipping to a key market area for a fifteen day period prior to the date the rate calculation is performed. If insufficient rate data is found to satisfy minimum requirements, the time frame can be expanded to the thirty day period prior to the date the rate calculation is performed. This temporal expansion can be increased out to any appropriate time frame. A preferred embodiment of the system and invention offers expansions to 15-, 30-, 60-, 90-days and one year. However, any arbitrary expansion is possible.

Different initial time frames can be used for different key market areas. For example, more commonly used lanes can have default time windows of fifteen days, and less commonly used lanes can have default time windows of, for example, thirty or sixty days. Therefore, the system of the invention can generate a table of date ranges for performing expansions of the time frame, i.e., of the age of the rate data used to calculate the rate for a given geography. One such table is shown below. The date ranges shown in the Date Range Expansions Table can refer to the pickup dates for the past n days that are between (today-n) days and today, inclusive. It is not necessary to consider the time of the day that the pickup is performed:

DATE RANGE EXPANSIONS TABLE

| Order of Expansion | Date Range |
|---|---|
| 1 | 0-15 days |
| 2 | 0-30 days |
| 3 | 0-60 days |
| 4 | 0-90 days |
| 5 | 0-365 days |

Expanding both Geography and Temporal Currency. In a preferred embodiment of the invention, both dimensions of geography and temporal currency can be expanded in order to consider enough rate date to calculate a rate that satisfies the minimum requirements. Expansion Rules Table III illustrates:

EXPANSION RULES TABLE III

| Order of | | | |
|---|---|---|---|
| Expansion | Origin | Destination | Date Range |
| 1 | Postal Area | Postal Area | 0-15 |
| 2 | Postal Area | Key Market Area | 0-15 |
| 3 | Key Market Area | Key Market Area | 0-15 |
| 4 | Postal Area | Postal Area | 0-30 |
| 5 | Postal Area | Key Market Area | 0-30 |
| 6 | Key Market Area | Key Market Area | 0-30 |
| 7 | Key Market Area | State | 0-30 |
| 8 | State | State | 0-30 |
| 9 | Key Market Area | Key Market Area | 0-60 |
| 10 | Key Market Area | Key Market Area | 0-90 |
| 11 | State | State | 0-60 |
| 12 | State | State | 0-90 |
| 13 | Zone | Zone | 0-30 |
| 14 | Zone | Zone | 0-60 |
| 15 | Zone | Zone | 0-90 |
| 16 | Nation | Nation | 0-30 |

The above table also illustrates how both dimensions can be varied independently. In this example, geography is first contracted and then expanded as temporal currency is expanded. For each temporal expansion, geography is contracted, thus as older data is considered, a tighter geography is re-considered. This gives emphasis to the importance of geographic locality over temporal currency, but this could easily be reversed (i.e., giving priority to temporal currency over geographic locality), if needed.

Trip Type. Those skilled in the art will understand that the length of a trip (i.e., the distance from a shipment's pick-up origin to its delivery destination) can have a significant influence on the cost of shipping, beyond simple per-mile rates. Longer trips are influenced by cost factors such as overnight accommodations for drivers. Shorter trips must amortize baseline labor and pick-up costs across a shorter distance. For example, a trip whose origin and destination are at opposing ends of neighboring key market areas can be hundreds of miles in length. However, a trip whose origin and destination are near the shared border between those same neighboring key market areas will be vastly shorter. These two trips, although between the same key market areas, will likely have much different per-mile rates. Therefore, a calculation of shipping rates that does not give consideration to trip length can lead to misleading rates. The same effect is seen for trips that are entirely encompassed in the same market geography, especially the larger geographies, such as market regions, states, and zones.

The system and invention characterizes trips according to their distance, and uses the trip type as a third computational dimension (in addition to geographic locality and temporal currency) when calculating shipping rates. In one embodiment of the invention, the following trip type classifications are used:

TRIP TYPE TABLE I

| Trip Type | Distance (Miles) |
|---|---|
| Local | 1 to 50 |
| Short Haul | 51 to 250 |
| Next Day | 251 to 550 |
| Intermediate | 551 to 1100 |
| Long Haul | 1101 to 3450 |

Trip Type Overlap. Those skilled in the art will recognize that rate behavior is not discrete between trip types, i.e., a significant discontinuity in per-mile rates in a trip of 50 miles (“Local”) versus a trip of 51 miles (“Short Haul”) is not to be expected. Instead, rates tend to have significant overlap in terms of trip distance. The system and invention take this into account by assigning a “Matching Distance” to each trip type:

TRIP TYPE TABLE II

| Trip Type | Distance (Miles) | Matching Distance (Miles) |
|---|---|---|
| Local | 1 to 50 | 1 to 65 |
| Short Haul | 51 to 250 | 45 to 275 |
| Next Day | 251 to 550 | 226 to 605 |
| Intermediate | 551 to 1100 | 496 to 3450 |
| Long Haul | 1101 to 3450 | 496 to 3450 |

Exact Trip Type Matching. A user of the invention may request a rate for Vancouver, Wash. to Albany, Oreg. However, there may not be sufficient data to produce a rate for Vancouver, Wash. to Albany, Oreg. at the postal code to postal code level. According to the method of the invention, a geographic expansion can therefore be performed to expand out to the appropriate key market areas. Vancouver, Wash. and Albany, Oreg. are both in the Portland, Oreg. key market area. Much of the rate data in the Portland key market area is likely to be of the Local trip type, where the trip distance is less than 50 miles. The distance between Vancouver, Wash. and Albany, Oreg. is 81 miles. According to Trip Type Table II, above, this is a Short Haul rather than a Local trip. Therefore, data within the key market area on trips of 45-275 miles (i.e., the matching distance for the Local trip type) will give the most accurate rates.

Trip Type Expansion. Referring to the above table, a trip of length 48 miles is classified as a “Local” trip type. However, when considering matching distance, the trip may have rate characteristics of both Local and Short Haul trips, an example of overlapping trip types. The system and invention therefore can consider rate data from both Local and Short Haul trips when calculating a rate. As with geography and temporal locality, trip types can be expanded in order to obtain enough rate data to achieve a rate calculation that satisfies minimum requirements.

The following can be an example of the concept of trip type expansion using the Sample Rate Data Table, below. A customer may submit a rate request for a van from Portland, Oreg. to Walla Walla, Wash. The distance between Portland, Oreg. and Walla Walla, Wash. is 244 miles, as shown in row 1 of the Sample Rate Data Table. This falls into the category of Short Haul, as seen in the Trip Type Table II, above. There are only five rates in Short Haul trip type, insufficient to satisfy minimum requirements (eight rate records, for this example) and establish an adequate level of confidence in the calculated result.

Sample Rate Data Table

| | | | | Distance | Trip | Matching |
|---|---|---|---|---|---|---|
| City | State | City | State | (miles) | Type | Trip Types |
| Portland | OR | Walla Walla | WA | 244 | Short | Short Haul, |
| | | | | | Haul | Next Day |
| Salem | OR | Prosser | WA | 247 | Short | Short Haul, |
| | | | | | Haul | Next Day |
| Hermiston | OR | Woodinville | WA | 248 | Short | Short Haul, |
| | | | | | Haul | Next Day |
| Eugene | OR | Lakewood | WA | 249 | Short | Short Haul, |
| | | | | | Haul | Next Day |
| Eugene | OR | Lakewood | WA | 250 | Short | Short Haul, |
| | | | | | Haul | Next Day |
| Salem | OR | Marysville | WA | 255 | Next | Short Haul, |
| | | | | | Day | Next Day |
| Cornelius | OR | Oak Harbor | WA | 263 | Next | Short Haul, |
| | | | | | Day | Next Day |
| Gresham | OR | Bellingham | WA | 272 | Next | Short Haul, |
| | | | | | Day | Next Day |

Therefore, a trip type expansion can be performed, based on Matching Distance (see Trip Type Table II) from Short Haul to Next Day. This results in three more rate records being available, for a total of eight rate records, enough to satisfy minimum requirements and establish an adequate level of confidence in the calculated result.

Expansion of Geography, Temporal Currency, and Trip Type. The system and method of the invention can use expansion of all three dimensions to secure enough rate records to calculate a rate that satisfies minimum requirements.

FULL EXPANSION RULES TABLE

| | | | Date | Exactly |
|---|---|---|---|---|
| Order of | | | Range | Match |
| Expansion | Origin | Destination | (Days) | Trip Type |
| 1 | Postal Area | Postal Area | 0-15 | |
| 2 | Postal Area | Key Market Area | 0-15 | |
| 3 | Key Market Area | Key Market Area | 0-15 | |
| 4 | Postal Area | Postal Area | 0-30 | |
| 5 | Postal Area | Key Market Area | 0-30 | |
| 6 | Key Market Area | Key Market Area | 0-30 | ✓ |
| 7 | Key Market Area | State | 0-30 | ✓ |
| 8 | State | State | 0-30 | ✓ |
| 9 | Key Market Area | Key Market Area | 0-60 | |
| 10 | Key Market Area | Key Market Area | 0-90 | |
| 11 | State | State | 0-60 | ✓ |
| 12 | State | State | 0-90 | ✓ |
| 13 | Zone | Zone | 0-30 | ✓ |
| 14 | Zone | Zone | 0-60 | ✓ |
| 15 | Zone | Zone | 0-90 | ✓ |
| 16 | Nation | Nation | 0-30 | ✓ |

In another embodiment of the invention, the expansion rules of Full Expansion Rules Table, above, can be used. As with previous examples, the system uses the expansion in the first row (“Order of Expansion” is 1). If unable to find enough rate data to calculate a rate that meets minimum requires, the system can expand geography, date range, and trip type as specified in the second row (“Order of Expansion” is 2), and so on until enough rate data is found. A check mark in the “Match Trip Type” column indicates that expansion of trip type is not to be performed, but instead, the trip type must be exactly matched.

The table illustrates that not all three dimensions must be expanded at each level. For example, “Order of Expansion” rows 1 through 3 indicate expansion of geography and trip type, but not date range. Likewise, “Order of Expansion” rows 9 and 10 expand date range and trip type, but not geography. A check mark in the “Match Trip Type” column indicates that expansion of trip type is not to be performed, but instead, the trip type can be matched.

Another embodiment of the invention uses expansion rules whose geographic dimension is based solely on market characteristics (except possibly for the final expansion to national geography), and no trip type expansion except for freight pick-up dates in the last seven days:

FULL EXPANSION RULES TABLE II

| | | | Date | Exactly |
|---|---|---|---|---|
| Order of | | | Range | Match |
| Expansion | Origin | Destination | (Days) | Trip Type |
| 1 | Postal Area | Postal Area | 0-7 | |
| 2 | Postal Area | Key Market Area | 0-7 | |
| 3 | Key Market Area | Key Market Area | 0-7 | |
| 4 | Key Market Area | Expanded | 0-7 | |
| | | Market Area | | |
| 5 | Postal Area | Postal Area | 0-15 | ✓ |
| 6 | Postal Area | Key Market Area | 0-15 | ✓ |
| 7 | Key Market Area | Key Market Area | 0-15 | ✓ |
| 8 | Key Market Area | Expanded | 0-15 | ✓ |
| | | Market Area | | |
| 9 | Postal Area | Postal Area | 0-30 | ✓ |
| 10 | Postal Area | Key Market Area | 0-30 | ✓ |
| 11 | Key Market Area | Key Market Area | 0-30 | ✓ |
| 12 | Key Market Area | Expanded | 0-30 | ✓ |
| | | Market Area | | |
| 13 | Expanded | Expanded | 0-7 | |
| | Market Area | Market Area | | |
| 14 | Expanded | Market Region | 0-7 | |
| | Market Area | | | |
| 15 | Expanded | Expanded | 0-15 | ✓ |
| | Market Area | Market Area | | |
| 16 | Expanded | Market Region | 0-15 | ✓ |
| | Market Area | | | |
| 17 | Expanded | Expanded | 0-30 | ✓ |
| | Market Area | Market Area | | |
| 18 | Expanded | Market Region | 0-30 | ✓ |
| | Market Area | | | |
| 19 | Postal Area | Postal Area | 0-60 | ✓ |
| 20 | Postal Area | Key Market Area | 0-60 | ✓ |
| 21 | Key Market Area | Key Market Area | 0-60 | ✓ |
| 22 | Key Market Area | Expanded | 0-60 | ✓ |
| | | Market Area | | |
| 23 | Postal Area | Postal Area | 0-90 | ✓ |
| 24 | Postal Area | Key Market Area | 0-90 | ✓ |
| 25 | Key Market Area | Key Market Area | 0-90 | ✓ |
| 26 | Key Market Area | Expanded | 0-90 | ✓ |
| | | Market Area | | |
| 27 | Expanded | Expanded | 0-60 | ✓ |
| | Market Area | Market Area | | |
| 28 | Expanded | Market Region | 0-60 | ✓ |
| | Market Area | | | |
| 29 | Expanded | Expanded | 0-90 | ✓ |
| | Market Area | Market Area | | |
| 30 | Expanded | Market Region | 0-90 | ✓ |
| | Market Area | | | |
| 31 | Market Region | Market Region | 0-7 | |
| 32 | Market Region | Market Region | 0-15 | ✓ |
| 33 | Market Region | Market Region | 0-30 | ✓ |
| 34 | Market Region | Market Region | 0-60 | ✓ |
| 35 | Market Region | Market Region | 0-90 | ✓ |
| 36 | Postal Area | Postal Area | 0-365 | ✓ |
| 37 | Postal Area | Key Market Area | 0-365 | ✓ |
| 38 | Key Market Area | Key Market Area | 0-365 | ✓ |
| 39 | Key Market Area | Expanded | 0-365 | ✓ |
| | | Market Area | | |
| 40 | Expanded | Expanded | 0-365 | ✓ |
| | Market Area | Market Area | | |
| 41 | Expanded | Market Region | 0-365 | ✓ |
| | Market Area | | | |
| 42 | Market Region | Market Region | 0-365 | ✓ |
| 43 | Nation | Nation | 0-30 | ✓ |

Expansion rules, as expressed in Full Expansion Rules Tables I and II, can be established and modified by the operators of the invention, and can therefore be customized to changing market conditions and user needs.

Contributor's Own Rate. The system and method of the invention can calculate a shipping rate using just the rate data contributed by the requestor, still using the above described geographic, temporal, and trip type expansions and matching. This result can then be compared to the shipping rate calculated using all rate data from all contributors. This comparison is valuable to the requestor in analyzing profitability for specific shipping lanes.

Historical Rates. As explained in previous sections, the temporal currency of rate data can be expanded and contracted when calculating a rate. The temporal currency can also be set to a fixed arbitrary date range in the past, for example Jul. 1, 2010 through Jul. 31, 2010. This means the rate calculation will only consider rates with a freight pick-up date in the specified range. The result is not a calculated rate that reflects current market conditions, but rather, historical market conditions during the specified time frame. The preferred embodiment of the system and invention calculates historical rates on a monthly basis for arbitrary date ranges (e.g., each month between July 2010 through July 2011), but a historical rate can be calculated for any arbitrary and specific date range for which rate data is available.

Specific Geography and Temporal Currency. The system and method of invention allows a specific geographic expansion and temporal currency to be specified when requesting a rate calculation. For example, the rate request can be made for vans from Portland, Oreg. to Dallas, Tex., specifying state (Oregon) for the origin geographic expansion, and key market area (Dallas-Fort Worth Key Market Area) for the destination geographic expansion, and rates with a pick-up date in the last 30 days. If insufficient rate data can be found to calculate a rate that meets minimum criteria, then no further geographic or temporal expansion will be performed.

Weighting and Anonymization of Rate Data. The system and method of invention takes steps to prevent an overwhelming amount of rate data from a single contributor from both (1) unduly influencing the calculated rate and (2) implicitly revealing the identity of the contributor to those familiar with prevailing rates in the industry. In one embodiment of the invention, rate data is inversely weighted according to the number of rates contributed by each contributor. This has the result of preventing the rate of any one contributor from overly influencing the calculated rate, and prevents implicitly revealing the identity of the contributor to those in the industry familiar with the contributor's rates.

Collection of Rate Data. Data for calculating lane rates can be collected from any parties involved in shipping, including transportation brokers, carriers, and shippers. The information from these contributors can include additional information regarding the freight shipment, such as commodity type, equipment type, trip distance, fuel cost, assessorial costs, and any other information useful for determining rates. The data can be collected on an ongoing basis, for example by way of the transportation management systems (TMS), logistics management systems, accounts receivable, invoice systems or other accounting systems, market rate aggregators, or any other appropriate electronic publication.

In another preferred embodiment of the invention, rates can be collected at the rate confirmation stage. This early data collection method can permit the calculation of shipping rates that are timelier than rates calculated from invoices. For example, in a preferred embodiment of the invention, the system and method of the invention can obtain the rate data for calculating shipping rates from the operations systems of entities in the shipping business, for example from the operating systems of transportation brokers. Those skilled in the art will understand that the rate information in the operations systems is available earlier than the information in the financial systems, since the financial systems do not capture the data until completion of the shipment. This can be especially useful in cases where materials are shipped for long distances. For example, rate information for shipments across the United States is available three or four days earlier if it is obtained from the operations systems, rather than from the financial systems. It is also within the broadest scope of the present invention to also include a cross check (e.g., an audit) with the financial systems, once they do capture the data upon completion of the shipment, with the information from the operations systems. Such a combination of comparison data would also support providing trends.

Additionally, updating mechanisms for updating rate data from operations systems can be made available for calculating the shipping rates using the system and method of the invention. For example, if a transportation broker enters a negotiated rate into its operating system and it is later determined, for example, that the characteristics of the load are different from the expected characteristics, the transportation broker can enter an updated rate into its operations system. The updated rate placed in the operations system of the transportation broker can then be used in any of the shipping rate calculations of the invention. This can be accomplished, for example, by assigning an identification number to each item of rate data entered into the operations systems, and assigning the same identification number to both an original item of rate data and an updated item of rate data.

A contributed rate can be broken down into a line haul rate, plus other costs such as fuel surcharges, accessorial charges etc. The line haul rate therefore is the rate for a shipment when there is nothing special about the shipment, for example, when there is no special handling. It is this line haul rate that responds to the market forces resulting from the supply of trucks and the demand for trucks in the market. Therefore, if the supply of available trucks is low and the demand is high, the line haul rate will respond by increasing. Conversely, if the supply of trucks is high and the demand is low, the line haul rate will respond by decreasing. The fuel costs and the accessorial charges will move according to their own market forces, separately from movements of the line haul rate.

Furthermore, fuel surcharges can be standardized by combining reported fuel surcharges and line haul rate into a total rate, and breaking out a calculated fuel surcharge based on fuel price at the time of the move. This standardization procedure can be very helpful in calculating an accurate line haul rate.

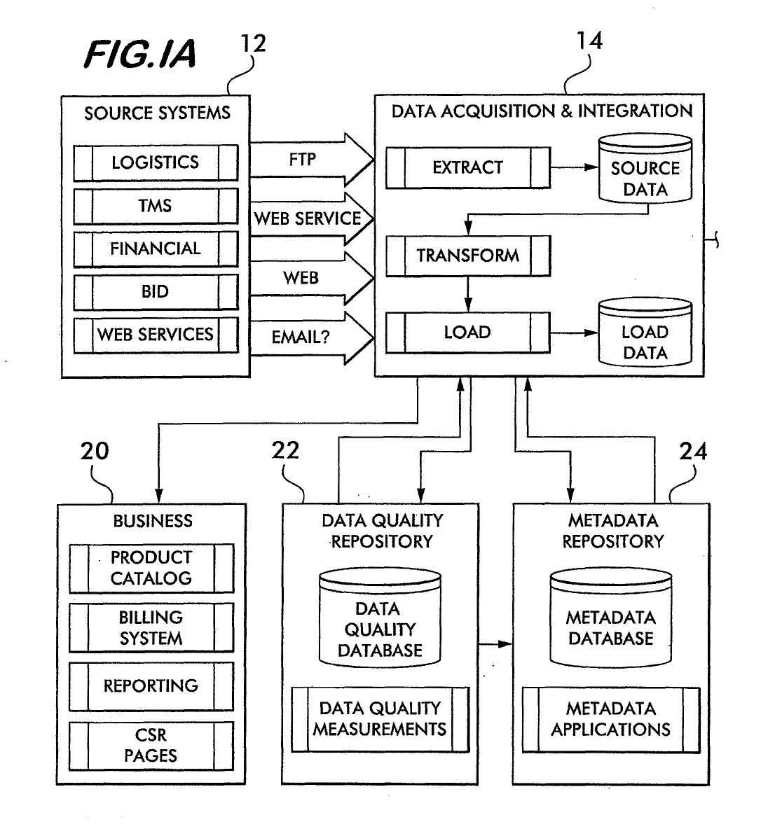

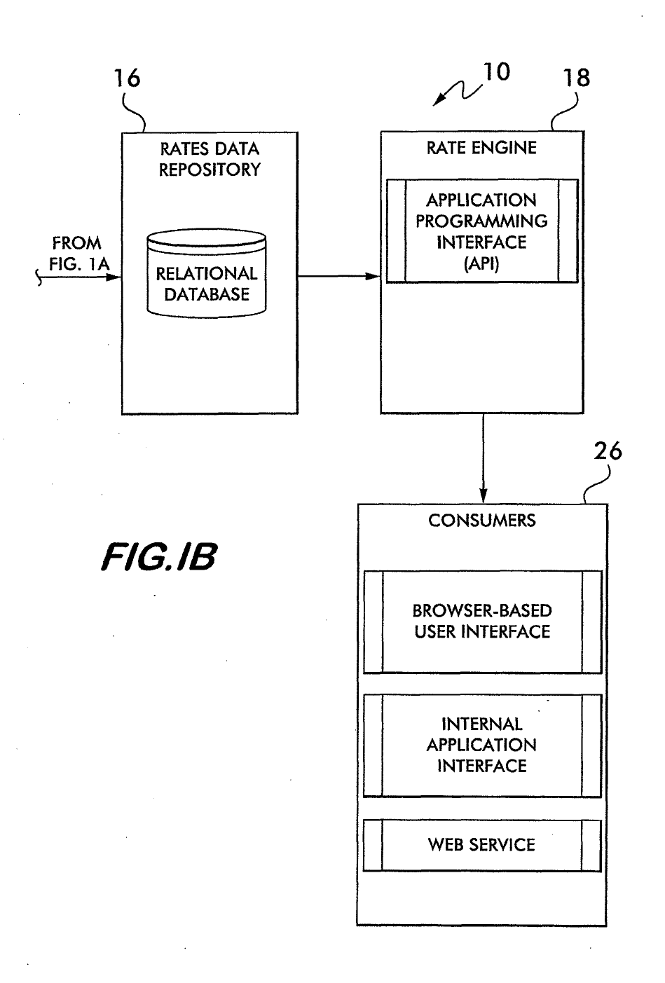

Referring now to FIGS. 1A-1B, there is shown a process flow representation of the system and method 10 for calculating the cost (rate) of shipping freight from an origin location to a destination location. In the method 10, the source systems 12 can include all of the information gathering and information inputting systems that are located at the sites of any number of different sources, for example any number of different customers and rate submitters, using commercially available or proprietary logistics, transportation management, accounting, etc., system software applications. A data mapping utility can be used on the data from the source systems 12 in order to improve the chances of receiving properly formed data from the source systems 12.

Customers of the system and method 10 can also share rate information with the system of the invention using any of the source systems 12. The information obtained and gathered at the source systems 12 can be transmitted from the source systems for uploading by any information transmission systems available. For example, the information can be transmitted by File Transfer Protocol (FTP), web services, web uploads, e-mail and any other appropriate electronic means.

The volume of information from the source systems 12 can be very large. Furthermore, the uploaded information can be in any number of different formats. Therefore, the information from the source systems 12 is received and extracted by the data acquisition and integration block 14. The received and extracted information is also transformed from the different formats as needed into formats that can be utilized in the internal operations of the method 10 by the data acquisition and integration block 14. The methods used in block 14 for transforming the information into the formats which can be utilized in the internal operations of the method 10 can be any information transformation methods known to those skilled in the art. It will be understood that a large number of different customized information transformation processes may be required for this purpose within block 14.

Information from the data acquisition and integration block 14 can then be stored in several databases within the method 10. For example, the information from the data acquisition and integration block 14 can be stored in a relational database within the rates data repository 16. This information will be used for calculating rates, and the relational database within the rates data repository 16 can all be used as a reporting database. There is no requirement by the method 10 that the databases be relational databases. The preferred embodiment uses relational databases because of convenience and familiarity by the practitioners.

Rate Engine 18 calculates shipping rates using the methods and expansions described in previous sections. Individual rate data is sourced from Rates Data Repository 16. Consumers of the calculated rates input their request criteria, and receive the resulting rates, via an application programming interface (API) provided by the Rate Engine 18.

The API within the Rate Engine 18 can support both single and bulk (batch) rate requests, and any other requests and submissions typical in the field of rate calculation. Bulk rate requests can also be made by the user uploading a file of request criteria to the Rate Engine 18. The resulting batch of calculated rates can then be downloaded by the requestor. The preferred embodiment supports bulk requests in a traditional comma-separated fields format text file, typically generated from the requestor' s transportation or financial systems, or even manually generated using a text editor or spreadsheet application. It likewise generates a downloadable common-separated field format text file for the calculated rate results.

In a preferred embodiment of the invention, both a per-mile and total trip rate is determined for each requested trip. Statistical high and low bounds for each rate are also calculated. Rates and bounds are calculated using traditional statistical methods based on means and standard deviation.

Additional metadata regarding the calculation method, number of rate reports used, number of contributors of rates, geography, time frame, trip type, load/truck demand ratios, and other pertinent information is also returned to the requestor.

The rate calculation output of the Rating Engine 18 can be sold to the customers 26. Customers 26 can include any applications or entities receiving output information from the method 10, for example, web applications and applications using web services.

The information from the data acquisition and integration block 14 can also be transmitted to the business block 20. The operations of the method 10 performed in the business block 20 can include product catalog operations, billing system operations, internal reporting operations and customer support operations.

The data quality repository 22 can also receive information from the data acquisition and integration block 14. A data quality database within the data quality repository 22 can store the received information. The stored information can be used for internal data quality measurements for monitoring the accuracy, completeness and confidence of the rate data. Reports on the data quality can be generated and reviewed in order to help maintain data quality.

A metadata database within a metadata repository 24 can also receive information from the data acquisition and integration block 14. Metadata applications within the metadata repository 24 can provide background and context to the information stored in the rates data depository 16.

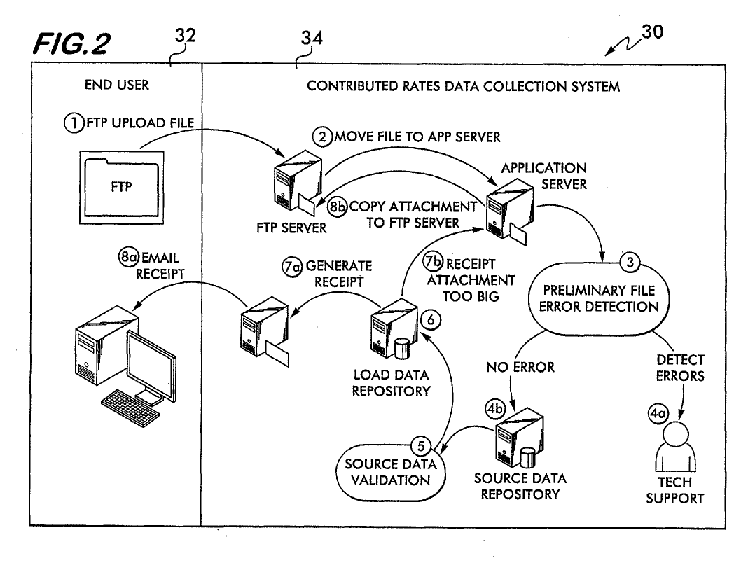

Referring now to FIG. 2, there is shown a block diagram representation 30. The block diagram representation 30 includes an end user block 32 and a broker rates system block 34. The block diagram representation 30 provides a more detailed description of some of the data upload operations of the data acquisition and integration operations within the method 10. In the block diagram representation 30 a file of contributed rates to be uploaded from the end user block 32 for use in rate calculation is transmitted to an FTP server at the contributed rates data collection system block 34 in step 1. From the FTP server it is transmitted to the application server in step 2. In the preferred embodiment of the invention a receipt can be generated.

The receipt can permit a user submitting a file to method 10 to know whether the submission has succeeded or failed. Therefore, the receipt can include the date and time the upload file is received, the name of the upload file, the total number of records received, the total number of new records accepted, the total number of updated records accepted, the total number of records rejected, and an attachment including the rejected records and their corresponding error messages.

Therefore, preliminary file error detection can be performed at step 3. If an error is detected tech support can be notified as shown in step 4a, and the error can be diagnosed and corrected. If no error is detected the data can be transmitted to the source data repository as shown in step 4b. Source data validation can be performed on the data in the source data repository in step 5. If the data is validated it is transmitted to the load data repository in step 6. In step 7a the receipt is generated and in step 8a the receipt can be emailed to the end user in end user block 32. If there are many errors the information can go back to the application server in step 7b, and a copy attachment to the FTP server can be performed in step 8b.

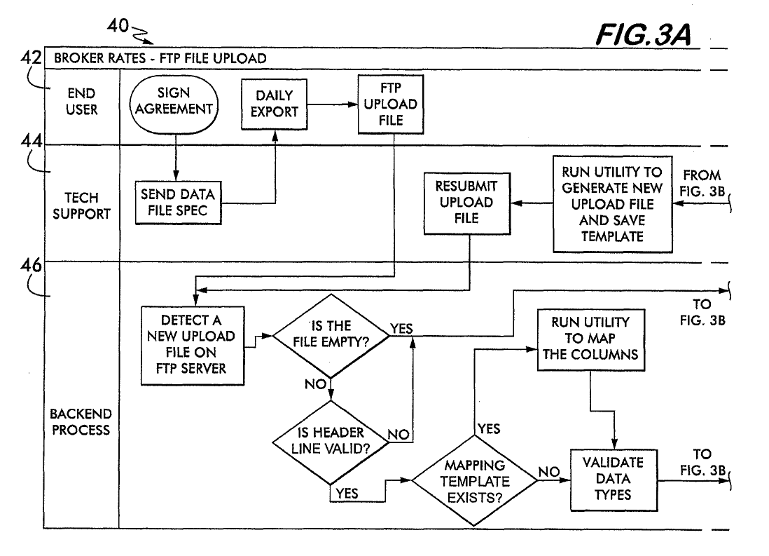

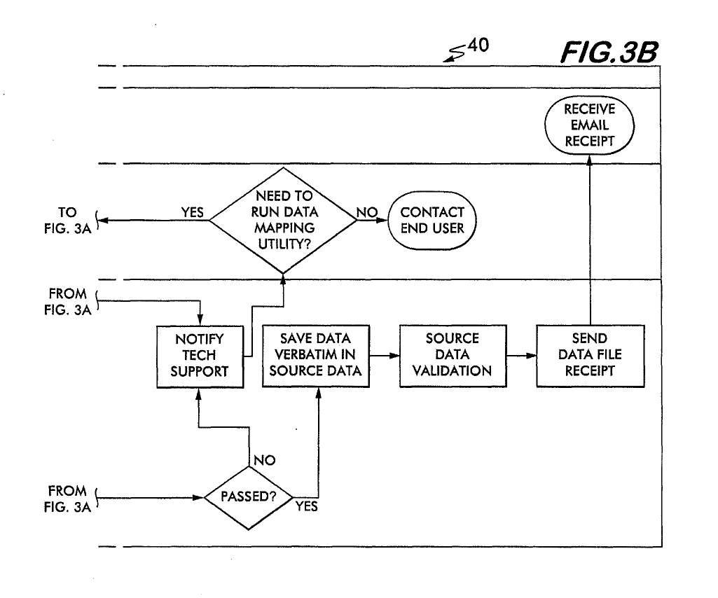

Referring now to FIGS. 3A-3B, there is shown a block diagram representation 40. The block diagram representation 40 includes an end user block 42, a tech support block 44, and a backend process block 46. Thus, the block diagram representation 40 provides further details on the data upload process within the key market area pricing method 10. Additionally, the block diagram 40 provides further details on the tech support and backend process within the key market area pricing method 10.

Within the end user block 42, the user can sign an agreement. The end user can also provide a data file containing the information to be uploaded. The data file can be transmitted to the tech support block 44. The tech support block 44 can locate or develop a transformation for transforming the data in the data file received from the end user into a format usable by the key market area pricing method 10. The data can then be transmitted during the daily export, and an FTP upload can be performed.

Within the backend process 46 the newly uploaded file can be detected on the FTP server. If the file is empty tech support can be notified. The header of the file can be examined. If the header is not valid tech support can be notified. Additionally, the end user can be notified by the tech support.

If the file is not empty a determination can be made whether the file header is valid. If the file header is not valid tech support can be notified. Determinations can also be made whether the file is readable, whether the data type is correct for each column in the file, whether the file is a duplicate of a previously submitted file, and whether other relevant criteria are met. If the file header is valid a determination can be made whether a mapping template exists for the file. If the mapping template exists a utility is run to map the columns of the file into the date fields used by the method 10. If the mapping operations pass, the information in the uploaded file is stored in the source data and validated. The receipt can then be generated and transmitted to the end user by the backend process 46.

Presentation of Calculated Rates to Interactive Users. In a preferred embodiment of the invention, the calculated rates, the contributor's own rate, and other ancillary information and metadata (see previous sections) can be presented to an interactive user via a web browser.

Sliders on a user display can be used to request specific geographic expansion and contraction, and the time window expansion and contraction when performing calculations of rates. In a preferred embodiment of the invention, interaction between two slider controls can permit expanding one of one parameter to automatically narrow the other parameter, or to permit the narrowing of one parameter to automatically expand the other. Additionally, controls can show geographic and time frame expansions and contractions that cannot be selected because there is insufficient data to calculate a rate that meets minimum requirements for that expansion or contraction.

The operations of the system and method of the invention can be run on computer systems having processors for executing instructions embodying the operations of the invention. The computer systems can also have any architecture and any other processor or computer devices commonly known to those skilled in the art, including servers, memory and input and output devices. The output devices can include printers and monitors for printing and displaying information at any stage in the operations of the system and method of the invention. Windows XP, Windows Vista, Windows 7, Solaris, UNIX, Linux, or any other suitable operating system can be used by the system and method of the invention. Furthermore, the system and method of the invention can use web browsers that support the implemented display tools and technologies (e.g., AJAX, JavaScript). These browsers include recent versions of Internet Explorer, Firefox, Chrome, and other web browsers.

While the invention has been described in detail and with reference to specific examples thereof, it will be apparent to one skilled in the art that various changes and modifications can be made therein without departing from the spirit and scope thereof.

What is claimed is:

1. A method for determining the shipping price rates of goods to be shipped in geographic areas, said method comprising:
defining geographic areas in terms of similar market characteristics;
defining age of rate data;
defining a respective set of expansion rules for said geographic areas and said age of rate data;
associating said expansion rules of said geographic areas and said age of rate data;
alternately expanding and contracting said geographic areas with said age of rate data based on a request for a shipping rate for goods between a particular origin and a particular destination to determine the shipping price rate therebetween, said alternate expanding and contracting meeting respective minimum requirements of said geographic areas and said age of rate data.

2. The method of claim 1 wherein said method further comprises the steps of:
defining shipping trip types in terms of distance;
defining a set of expansion rules for said shipping trip type;
associating said expansion rules of said shipping trip type with said associated expansion rules of said geographic areas and said age of rate data; and
wherein said step of alternately expanding and contracting comprises said alternately expanding and contracting said geographic areas with said age of rate data and with said shipping trip type based on a request for a shipping rate for goods between a particular origin and a particular destination to determine the shipping price rate therebetween, said alternate expanding and contracting meeting respective minimum requirements of said geographic areas, said age of rate data and said shipping trip type.

3. The method of claim 1 wherein one of said geographic areas comprises a postal area.

4. The method of claim 1 wherein one of said geographic areas comprises a key market area.

5. The method of claim 1 wherein one of said geographic areas comprises an expanded market area.

6. The method of claim 1 wherein one of said geographic areas comprises a market region.

7. The method of claim 1 wherein one of said geographic areas comprises a state.

8. The method of claim 1 wherein one of said geographic areas comprises a zone.

9. The method of claim 1 wherein one of said geographic areas comprises a nation.

10. The method of claim 2 wherein said step of defining shipping trip types in terms of distance further comprises associating any two adjacent shipping trip types to have respective overlapping portions of distance to form a respective associated term of distance referred to as a matching distance.

11. The method of claim 10 wherein one of said two adjacent trip types comprises a local trip and a short trip.

12. The method of claim 10 wherein one of said two adjacent trip types comprises a short trip and a next day trip.

13. The method of claim 10 wherein one of said two adjacent trip types comprises a next day trip and an intermediate trip.

14. The method of claim 10 wherein one of said two adjacent trip types comprises an intermediate trip and a long haul trip.

15. The method of claim 2 further comprising the step of including rate data provided by a requester of said request.

16. The method of claim 2 further comprising the step of including an historical rate, said historical rate reflecting market conditions during a specified time frame.

17. The method of claim 2 further comprising the step of identifying a specific geographic expansion that is different from said step of defining geographic areas.

18. The method of claim 2 wherein said step of defining rate data is weighted and anonymized to avoid unduly influencing said determined shipping price rates of goods.

19. The method of claim 2 wherein said step of defining rate data comprises obtaining rate data from operations systems of shipping entity businesses.

20. The method of claim 19 further comprising the step of updating rate data from said operations systems, said step of updating rate data comprising assigning an identification number to both an original rate data item and an updated rate data item.

21. The method of claim 19 wherein said step of obtaining rate data from operations systems further comprises comparing such data with data from financial systems.

22. The method of claim 1 wherein said step of determining the shipping price rate comprises calculating both a per-mile and a total trip rate.

23. A system for determining the shipping price rates of goods to be shipped in geographic areas, said system comprising:
at least one computer system that provides source system data pertaining to shipping rates;
a rate engine that receives said source system data from said at least one computer system, said rate engine calculating the shipping price rates of goods to be shipped from an association of expansion rules of predefined geographic areas that are defined in terms of similar market characteristics and expansion rules of predefined age of rate data, said rate engine alternately expanding and contracting said predefined geographic areas with said predefined age of rate data based on a user request for a shipping rate for goods between a particular origin and a particular destination to determine the shipping price rate therebetween, said alternate expanding and contracting meeting respective minimum requirements of said geographic areas and said age of rate data; and
at least one computer of a user, making said request, for receiving said determined shipping price rate.

24. The system of claim 23 wherein said rate engine further comprises expansion rules of predefined shipping trip types in terms of distance, said rate engine associating said expansion rules of said predefined shipping trip types along with said associated expansion rules of said predefined geographic areas and said predefined age of rate data and wherein said rate engine alternately expands and contracts said predefined geographic areas with said predefined age of rate data and with said predefined shipping trip type based on a request for a shipping rate for goods between a particular origin and a particular destination to determine the shipping price rate therebetween, said alternate expanding and contracting meeting respective minimum requirements of said predefined geographic areas, said predefined age of rate data and said predefined shipping trip type.

25. The system of claim 23 wherein one of said predefined geographic areas comprises a postal area.

26. The system of claim 23 wherein one of said predefined geographic areas comprises a key market area.

27. The system of claim 23 wherein one of said predefined geographic areas comprises an expanded market area.

28. The system of claim 23 wherein one of said predefined geographic areas comprises a market region.

29. The system of claim 23 wherein one of said predefined geographic areas comprises a state.

30. The system of claim 23 wherein one of said predefined geographic areas comprises a zone.

31. The system of claim 23 wherein one of said predefined geographic areas comprises a nation.

32. The system of claim 24 wherein said rate engine associates any two adjacent shipping trip types to have respective overlapping portions of distance to form a respective associated term of distance referred to as a matching distance.

33. The system of claim 32 wherein one of said two adjacent trip types comprises a local trip and a short trip.

34. The system of claim 32 wherein one of said two adjacent trip types comprises a short trip and a next day trip.

35. The system of claim 32 wherein one of said two adjacent trip types comprises a next day trip and an intermediate trip.

36. The system of claim 32 wherein one of said two adjacent trip types comprises an intermediate trip and a long haul trip.

37. The system of claim 24 further comprising the step of including rate data provided by a requester of said request.

38. The system of claim 23 wherein said at least one at least one computer system of source data comprises logistics information.

39. The system of claim 23 wherein said at least one at least one computer system of source data comprises transportation management systems information.

40. The system of claim 23 wherein said at least one at least one computer system of source data comprises financial information.

41. The system of claim 23 wherein said at least one at least one computer system of source data comprises bidding information.

42. The system of claim 23 wherein said at least one at least one computer system of source data comprises web services information.

43. The system of claim 23 further comprising a rates data repository, said rates data repository receiving and storing said source system data.

44. The system of claim 43 further comprising a data acquisition and integration system that extracts and reconfigures source system data for use by said rate engine.
